(19) United States
(12) Patent Application Publication
(10) Pub. No.: US 2026/0319459 A1
(43) Pub. Date: Oct. 15, 2026

(54) SELECTABLE DATASETS FOR MACHINE LEARNING MODELS

(71) Applicant: Rockwell Automation Technologies, Inc., Mayfield Heights, OH (US)

(72) Inventors: Roberto S. Marques, Cedarburg, WI (US); Patrick E. Ozimek, Elm Grove, WI (US)

(21) Appl. No.: 19/175,832

(22) Filed: Apr. 10, 2025

(51) Int. Cl. G05B 19/4097; G06F 21/62; G06F 8/61

(52) U.S. Cl. CPC G05B 19/4097; G06F 21/6254; G05B 2219/42155; G06F 8/61

(57) ABSTRACT

A system may include an industrial device and a processing system. The processing system may receive an anonymized dataset associated with operations of the industrial device from a control system associated with the industrial device, identify a model representative of expected operations of the industrial device over time based on the dataset, update the model based on the dataset to generate an updated model, and generate a device model representative of expected outputs associated with the operations of the industrial device based on the dataset and the updated model. Further, the processing system may generate instructions for modifying the operations of the industrial device based on the device model and send the instructions to the control system. The control system may modify the operations of the industrial device based on the instructions.

### BACKGROUND

The present disclosure generally relates to data collection within industrial automation systems. More specifically, the present disclosure relates to a system for presenting various datasets for customers to select to share with machine learning systems. The machine learning systems may use the datasets to better train machine learning models.

Machine learning models for various industrial automation systems and devices may be generated based on the datasets provided by various customers. Traditionally, requesting data from customers is a binary opt in or opt out agreement, in which the customers share either all or none of their data. However, some customers may be interested in sharing a portion or subset of the datasets that their respective devices may obtain or produce, so long as, for example, data associated with their proprietary systems and processes are not shared. As such, non-binary data sharing agreements may be desired.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a system may include an industrial device in operation within an industrial system and a processing system. The processing system may be configured to receive an anonymized dataset associated with one or more operations of the industrial device from a control system associated with the industrial device, and identify a model representative of one or more expected operations of the industrial device over time based on the dataset, where the model is generated based on a plurality of anonymized datasets associated with a plurality of industrial devices corresponding to the industrial device. Further, the processing system may be configured to update the model based on the dataset to generate an updated model, and generate a device model based on the dataset and the updated model, where the device model is representative of one or more expected outputs associated with the one or more operations of the industrial device. Additionally, the processing system may be configured to generate one or more instructions for modifying the one or more operations of the industrial device based on the device model, and send the one or more instructions to the control system, where the control system is configured to modify the one or more operations of the industrial device based on the one or more instructions.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example industrial automation system employed by a food manufacturer, in accordance with embodiments described herein;

FIG. 2 illustrates a diagrammatical representation of an exemplary data collection system that may be employed in any suitable industrial automation system, in accordance with embodiments described herein;

FIG. 3 illustrates example components that may be part of a device control system that may be part of the data collection system of FIG. 2, in accordance embodiments described herein;

FIG. 4 illustrates a flow chart of a data sharing process that may be performed by the device control system of FIG. 3, in accordance with embodiments described herein;

FIG. 5 illustrates a flow chart of a model training and data sharing process that may be performed by a cloud-based computing system that may be in communication with the device control system of FIG. 3, in accordance with embodiments described herein.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Machine learning systems may generate and train models that may be used to assist in the operation and maintenance of industrial automation devices and equipment. The generated models may use data gathered over a period of time (e.g., weeks, months, years) from one or more sensors, one or more control systems, and other devices that may be associated with one or more industrial automation devices. Since the amount of data sources may continuously be acquired and may consistently grow, training the models may involve an inefficient use of computing resources (e.g., energy, processing power, storage), may be cost prohibitive, and may be disruptive to a process. Nevertheless, machine learning models may be used in an industrial automation system to increase the efficiency of operations of an industrial device or process by detecting anomalies, maintenance events, and the like.

Accordingly, machine learning models for various industrial automation systems and devices may be generated based on the datasets provided by various customers. Traditionally, requesting data from customers is a binary opt in or opt out agreement, in which the customers share either all or none of their data. However, some customers may be interested in sharing a portion or subset of the datasets that their respective devices may obtain or produce, so long as, for example, data associated with their proprietary systems and processes are not shared. With this in mind, the present disclosure relates generally to a system for presenting various datasets for customers to select to share with machine learning systems to allow the machine learning systems to better train machine learning models.

In some embodiments, a data collection system may be implemented within an industrial automation system via a device control system coupled to an industrial automation device. As such, the data collection system may be deployed locally within a customer’s industrial automation system and may be adapted to interface with devices that may monitor and control various types of industrial automation equipment. By way of operation, the device control system may monitor and store data communication and outputs of the industrial automation device, such as, the acquisition of data from various data sources (e.g., sensors), data output (e.g., calculations, commands) by a respective controller, datasets transmitted or received by the industrial automation device, and the like. As the device control system monitors the datasets accessible to the industrial automation device, the device control system may categorize the datasets as raw data or process data. The raw data may relate to data acquired by sensors for various types of equipment, while the process data may relate to datasets that have been modified, altered, or generated by logic or software executed by the respective controller and/or the device control system.

After categorizing the accessible datasets, the data collection system may send types of data information to a machine learning system, such as a cloud-based computing system. The types of data information may include categories used to organize the accessible datasets, such as raw data and process data, as well as subcategories, such as thermal data, pressure data, position data, velocity data, etc. The machine learning system may be a cloud-based computing system, or any suitable computing system or combination of computing systems. The machine learning system may be operated by the manufacturer of the device control system, a software provider, a service provider, etc. In response to sending the types of data information, the device control system may receive an indication of operational model offerings related to each type of data information from the machine learning system. The operational model offerings may include inferences (e.g., suggested configuration data, common causes of operational anomalies, etc.) from a global model trained using data associated with the industrial automation device from various customers, as well as, device models generated for the customer based on properties of data shared with the machine learning system. The operational model offering may also include software patches and software applications that model the correlations between operational data and operations of the respective industrial automation device.

After receiving the indication of operational model offerings, the data collection system may present a visualization or request to a user of the device control system (e.g., the customer) to enable the user to select one or more portions of the detected datasets to make available to machine learning systems, such as the cloud-based computing system and the like. In some embodiments, the visualization or request may include an indication of the operational model offerings, such as a software patch or application that may be made available to the user in return for providing access to the respective data. That is, if the user provides access to temperature and operational data, the data collection system may identify software applications that model the correlations between the temperature and the operations of the respective device to provide operational adjustments to increase the lifespan of the respective device. Moreover, the selected datasets may be added to a data repository to allow various machine learning systems to perform various types of analysis to update models and the like.

The data collection system may receive a selection of one or more portions of the detected datasets to make available to machine learning systems. For example, the data collection system may receive inputs indicating the selection of one or more portions of the detected datasets via a user-interface or human-machine interface UI/HMI communicatively coupled to the device control system. After receiving the selection, the data collection system may retrieve data related to the selection. For example, the data collection system may query the industrial automation device, as well as, one or more databases stored in the memory of the device control system, to gather the selected one or more portions of the detected datasets. The data collection system may anonymize the retrieved dataset (i.e., remove any meta-data associating the dataset with the customer), and may send the anonymized retrieved dataset to the cloud-based computing system, or other suitable machine learning system(s).

In response, the cloud-based computing system may identify a global model (e.g., a machine learning model trained using datasets from various customers) associated with the industrial device and the data types (e.g., raw, processed, etc.) corresponding to the retrieved datasets. The cloud-based computing system may be in communication with various device control systems deployed within various industrial automation systems operated by various customers. Accordingly, the cloud-computing system may generate and train a plurality of global models based on datasets from various customers. When the cloud-based computing system receives an anonymized dataset, the computing system may identify a global model from the plurality of global models based on features of the anonymized dataset (e.g., the respective industrial device, the respective data type, etc.). For example, if the cloud-based computing system receives an anonymized dataset including temperature and operational data for a motor, the cloud-based computing system may identify a global model of the motor trained using temperature and operational data from various customers. Once the cloud-based computing system identifies a relevant global model, the cloud-based computing system may update the global model based on the anonymized dataset. In some embodiments, the cloud-based computing system may add data from the anonymized dataset to a data repository to allow various machine learning systems to perform various types of analysis to update models and the like.

Further, the cloud-based computing system may generate a device model for the industrial device based on the anonymized data and the updated global model. For example, the cloud-based computing device may identify and isolate portions of the updated global model related to the types of operational data contained in the anonymized dataset, such as sensor feedback (e.g., portions of the model related to thermal sensor data, pressure sensor data, etc.), and the like. As such, the device model may include correlations between the types of operational data contained in the anonymized dataset and operations of the industrial device, while excluding correlations between types of data not found in the anonymized dataset and operations of the industrial device, thereby generating a relevant model for the customer based on the shared data.

In some embodiments, the cloud-based computing system may send the device model to the customer. For example, the cloud-based computing system may send the device model directly to the device control system, or indirectly via any suitable computing device associated with customer and communicatively coupled to the device control system. After receiving the device model, the device control system may adjust operations of the industrial device based on the device model. For example, if the device model includes correlations between the temperature and the operations of the industrial device and suggests operational adjustments (e.g., updated configuration data) to increase the lifespan of the industrial device, the device control system may implement the suggested operational adjustments (e.g., deploying updated configuration data). Additionally, or alternatively, the cloud-based computing system may generate or identify instructions for modifying operations of the industrial device based on the device model, and may send the instructions to the device control system in return for providing access to the respective data. For example, the cloud-based computing system may identify a software application that models correlations between the pressure and the operations of the respective industrial device, and may send the software application to the control system for implementation in return for providing access to pressure and operational data. The instructions may also include modifications to configuration data, software patches, and the like.

The data collection system may send data indicating updates to portions of the anonymized datasets to the cloud-based computing system as the industrial device continues to operate. For example, the device control system may continuously share updates to the anonymized datasets (e.g., new data corresponding to the selected type(s) of data), and/or may share updates to the anonymized datasets at predetermined time intervals (e.g., every minute, hour, day, week, etc.). Accordingly, the cloud-based computing system may update relevant global models and device models continuously or at predetermined intervals as it receives updates to the anonymized datasets. Accordingly, the global models and device models may capture and represent changes to expected operations of industrial devices over time.

The cloud-based computing system may update the relevant global models based on the updated anonymized dataset (e.g., may train relevant global models based on the updated anonymized dataset, may add the updated anonymized dataset to a data repository, etc.). The cloud-based computing system may generate an updated device model based on the updated anonymized dataset and the updated global model. For example, the cloud-based computing device may generate the updated device model by identifying and isolating portions of the updated global model related to the types of operational data contained in the updated anonymized dataset, such as sensor feedback (e.g., portions of the model related to thermal sensor data, pressure sensor data, etc.), and the like. The cloud-based computing system may compare the updated device model to the device model. If the updated device model is within a threshold (e.g., 0.5% deviation, 5% deviation, etc.) of the device model, the cloud-based computing system may continue to receive updates to the anonymized data from the data collection system, without sending the updated device model to the customer (e.g., to the device control system). If the updated device model is not within the threshold of the device model, the cloud-based computing system may send the updated device model to the device control system. Additionally, or alternatively, the cloud-based computing system may generate or identify additional instructions for modifying operations of the industrial device based on the updated device model, and may send the additional instruction to the device control system if they are not within a threshold (e.g., 0.5% deviation, 5% deviation, etc.) of the instructions. In this way, the cloud-based computing system may only send updated device models or additional instructions (e.g., suggested configuration data, applications, and the like), when the updated anonymized datasets cause a substantive change in the device model or instructions.

Accordingly, the data collection system may present various datasets associated with an industrial automation device for customers to select to share with machine learning systems, such as the cloud-based computing system, to allow the machine learning systems to better train machine learning models. The machine learning models may be used in an industrial automation system to increase the efficiency of operations of the industrial device or related process by detecting anomalies, maintenance events, and the like.

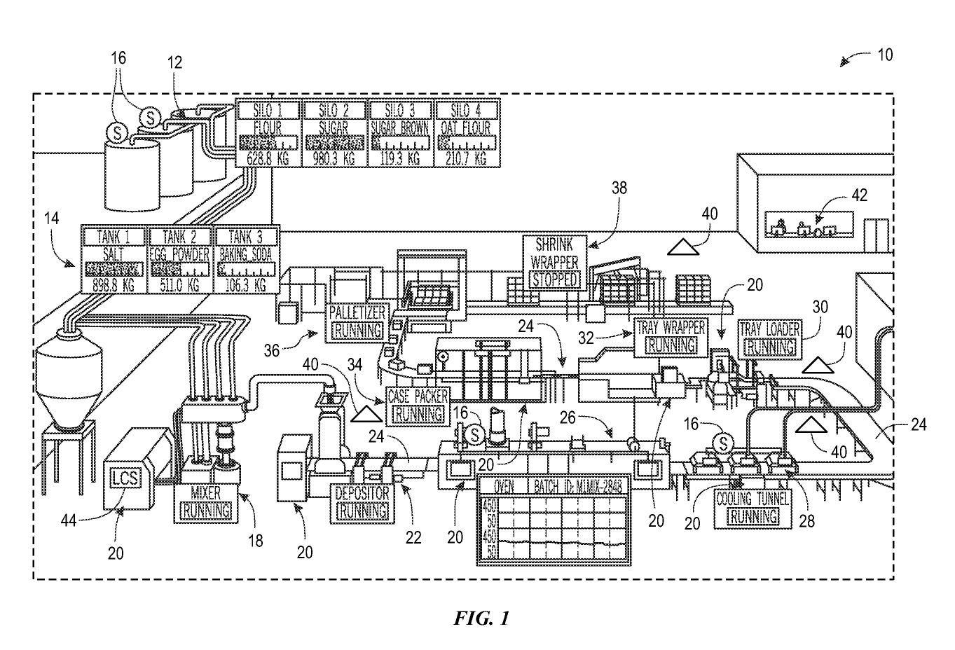

By way of introduction, FIG. 1 illustrates an example industrial automation system 10 employed by a food manufacturer. The present embodiments described herein may be implemented within various devices illustrated in the industrial automation system 10 described below. However, it should be noted that although the example industrial automation system 10 of FIG. 1 is directed at a food manufacturer, the present embodiments described herein may be employed within any suitable industry, such as automotive, mining, hydrocarbon production, manufacturing, and the like. The following brief description of the example industrial automation system 10 employed by the food manufacturer is provided herein to help facilitate a more comprehensive understanding of how the embodiments described herein may be applied to industrial devices to significantly improve the operations of the respective industrial automation system. As such, the embodiments described herein should not be limited to be applied to the example depicted in FIG. 1.

Referring now to FIG. 1, the example industrial automation system 10 for a food manufacturer may include silos 12 and tanks 14. The silos 12 and the tanks 14 may store different types of raw material, such as grains, salt, yeast, sweeteners, flavoring agents, coloring agents, vitamins, minerals, and preservatives. In some embodiments, sensors 16 may be positioned within or around the silos 12, the tanks 14, or other suitable locations within the industrial automation system 10 to measure certain properties, such as temperature, mass, volume, pressure, humidity, and the like.

The raw materials may be provided to a mixer 18, which may mix the raw materials together according to a specified ratio. The mixer 18 and other machines in the industrial automation system 10 may employ certain industrial automation devices 20 to control the operations of the mixer 18 and other machines. The industrial automation devices 20 may include controllers, input/output (I/O) modules, motor control centers, motors, human machine interfaces (HMIs), operator interfaces, contactors, starters, sensors 16, actuators, conveyors, drives, relays, protection devices, switchgear, compressors, sensor, actuator, firewall, network switches (e.g., Ethernet switches, modular-managed, fixed-managed, service-router, industrial, unmanaged, etc.) and the like.

The mixer 18 may provide a mixed compound to a depositor 22, which may deposit a certain amount of the mixed compound onto conveyor 24. The depositor 22 may deposit the mixed compound on the conveyor 24 according to a shape and amount that may be specified to a control system for the depositor 22. The conveyor 24 may be any suitable conveyor system that transports items to various types of machinery across the industrial automation system 10. For example, the conveyor 24 may transport deposited material from the depositor 22 to an oven 26, which may bake the deposited material. The baked material may be transported to a cooling tunnel 28 to cool the baked material, such that the cooled material may be transported to a tray loader 30 via the conveyor 24. The tray loader 30 may include machinery that receives a certain amount of the cooled material for packaging. By way of example, the tray loader 30 may receive 25 ounces of the cooled material, which may correspond to an amount of cereal provided in a cereal box.

A tray wrapper 32 may receive a collected amount of cooled material from the tray loader 30 into a bag, which may be sealed. The tray wrapper 32 may receive the collected amount of cooled material in a bag and seal the bag using appropriate machinery. The conveyor 24 may transport the bagged material to case packer 34, which may package the bagged material into a box. The boxes may be transported to a palletizer 36, which may stack a certain number of boxes on a pallet that may be lifted using a forklift or the like. The stacked boxes may then be transported to a shrink wrapper 38, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 10, the industrial automation devices 20 may provide power to the machinery used to perform certain tasks, provide protection to the machinery from electrical surges, prevent injuries from occurring with human operators in the industrial automation system 10, monitor the operations of the respective device, communicate data regarding the respective device to a supervisory control system 40, and the like. In some embodiments, each industrial automation device 20 or a group of industrial automation devices 20 may be controlled using a local control system 42. The local control system 42 may receive data regarding the operation of the respective industrial automation device 20, other industrial automation devices 20, user inputs, and other suitable inputs to control the operations of the respective industrial automation device(s) 20.

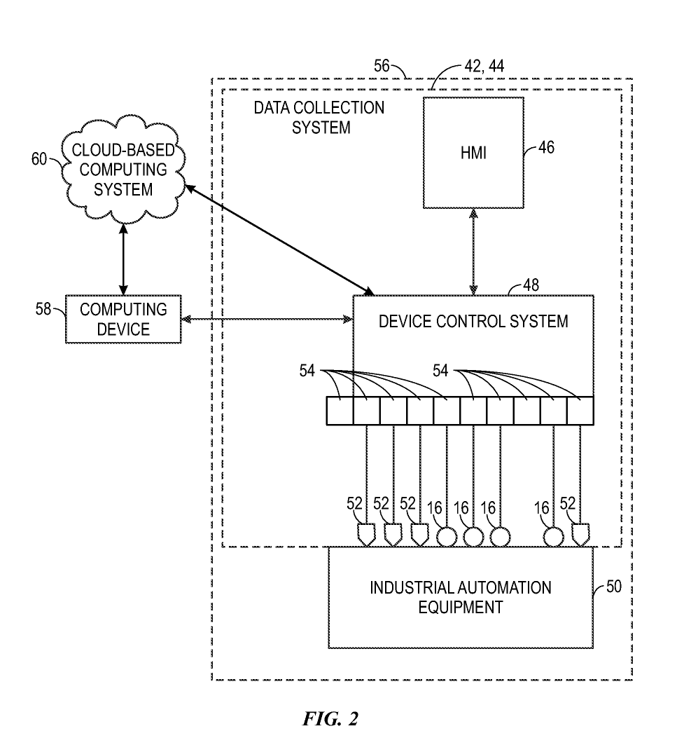

By way of example, FIG. 2 illustrates a diagrammatical representation of an exemplary local control system 42 that may be employed in any suitable industrial automation system 10, in accordance with embodiments presented herein. In FIG. 2, the local control system 42 includes a data collection system 44 that may gather and present various datasets associated with an industrial automation device for customers to select to share with machine learning systems to allow the machine learning systems to better train machine learning models.

The data collection system 44 is illustrated as including a human machine interface (HMI) 46 and a device control system 48. The HMI 46 may be any suitable device capable of receiving inputs from an operator (e.g., a selection of data to share, a command to implement an operational model offering, etc.) and communicating the inputs to the device control system 48. The device control system 48 may be an automation controller adapted to interface with devices that may monitor an industrial automation device 50. By way of operation, the device control system 48 may monitor and store data communication and outputs of the industrial automation device 50, such as, the acquisition of data from various data sources (e.g., sensors 16), data output (e.g., calculations, commands) by a respective controller, datasets transmitted or received by the industrial automation device 50, and the like. As the device control system 48 monitors the datasets accessible to the industrial automation device 50, the device control system 48 may categorize the datasets as raw data or processed data. The raw data may relate to data acquired by sensors 16 for various types of equipment, while the processed data may be related to datasets that have been modified, altered, or generated by logic or software executed by the respective controller and/or the device control system 48. The device control system 48 may be deployed to monitor and control various types of industrial automation devices.

The types of industrial automation devices may include controllers, input/output (I/O) modules, motor control centers, motors, human machine interfaces (HMIs), operator interfaces, contactors, starters, sensors 16, actuators, drives, relays, protection devices, switchgear, compressors, firewall, network switches (e.g., Ethernet switches, modular-managed, fixed-managed, service-router, industrial, unmanaged, etc.), and the like. The industrial automation device 50 may be used in various industrial environments, such a compressor station, an oil refinery, a batch operation for making food items, a mechanized assembly line, and so forth. Accordingly, the industrial automation device 50 may comprise, or be in communication with, a variety of operational components, such as electric motors, valves, actuators, temperature elements, pressure sensors, or a myriad of machinery used for manufacturing, processing, material handling, and other applications.

In some cases, the industrial automation device 50 may be associated with other devices in an industrial automation system. For example, the industrial device 50 may be a motor drive coupled to a motor (i.e., another industrial device) in order to carry out an industrial automation process. The industrial automation device 50 may include a communication component that enables the industrial device 50 to communicate data between itself and the other devices. The communication component may include a network interface that may enable the industrial automation device 50 to communicate via various protocols such as Ethernet/IP®, ControlNet®, DeviceNet®, or any other industrial communication network protocol. Alternatively, the communication component may enable the industrial automation device 50 to communicate via various wired or wireless communication protocols, such as Wi-Fi, mobile telecommunications technology (e.g., 2G, 3G, 4G, 5G, LTE), Bluetooth®, near-field communications technology, and the like.

Accordingly, the industrial automation device 50 may receive data from the associated devices via the communication component, and may use the data to perform its respective operations more efficiently. For example, a controller of a motor drive may receive data regarding a temperature of a connected motor and may adjust operations of the motor drive based on the data. The data may be measured by suitable operational components disposed on or within the industrial automation devices, such as scanner(s), gauge(s), valve(s), flow meter(s), and the like. Further, the device control system 48 may monitor, categorize, and store the data sent and received by the industrial automation device 50. The device control system 48 may compile the data into datasets associated with the type of operating data (e.g., raw or processed), and may tag the data in the datasets to indicate additional properties of the data, such as additional devices associated with the data (e.g., the additional industrial automation device that sent or received data from the industrial automation device 50), the device used to measure the data, and the like.

In certain embodiments, device control system 48 may be adapted to interface with sensors 16, actuators 52, and I/O modules 54, in order to monitor and control one or more properties of the industrial automation device 50. For example, the sensors 16 and actuators 52 may monitor various properties of the industrial automation device 50 and may provide data to the device control system 48, which may categorize and store the data, and adjust operations of the industrial automation device 50, accordingly.

The sensors 16 may be any number of devices adapted to provide information regarding process conditions. The actuators 52 may include any number of devices adapted to perform a mechanical action in response to a signal from a controller (e.g., the device control system 48). The sensors 16 and actuators 52 may be utilized to operate the industrial automation equipment 50. Indeed, they may be utilized within process loops that are monitored and controlled by the device control system 48 and/or the HMI 46. Such a process loop may be activated based on process input data (e.g., input from a sensor 16) or direct operator input received through the HMI 46. As illustrated, the sensors 16 and actuators 52 are in communication with the device control system 48. Further, the sensors 16 and actuators 52 may be assigned a particular address in the device control system 48 and receive power from the device control system 48 or attached modules.

Input/output (I/O) modules 54 may be added or removed from the data collection system 44 (e.g., device control system 48) via expansion slots, bays or other suitable mechanisms. In certain embodiments, the I/O modules 54 may be included to add functionality to the device control system 48, or to accommodate additional process features. For instance, the I/O modules 54 may communicate with new sensors 16 or actuators 52 added to monitor and control the industrial automation device 50. It should be noted that the I/O modules 54 may communicate directly to sensors 16 or actuators 52 through hardwired connections or may communicate through wired or wireless sensor networks, such as Hart or IOLink.

Generally, the I/O modules 54 serve as an electrical interface to the device control system 48 and may be located proximate or remote from the device control system 48, including remote network interfaces to associated systems. In such embodiments, data may be communicated with remote modules over a common communication link, or network, wherein modules on the network communicate via a standard communications protocol. Many industrial controllers can communicate via network technologies such as Ethernet (e.g., IEEE702.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems.

In the illustrated embodiment, several of the I/O modules 54 may transfer input and output signals between the device control system 48 and the industrial automation device 50. As illustrated, the sensors 16 and actuators 52 may communicate with the device control system 48 via one or more of the I/O modules 54 coupled to the device control system 48.

In certain embodiments, the data collection system 44 (e.g., the HMI 46, the device control system 48, the sensors 16, the actuators 52, the I/O modules 54) and the industrial automation device 50 may make up an industrial automation application 56. The industrial automation application 56 may involve any type of industrial process or system used to manufacture, produce, process, or package various types of items. For example, the industrial applications 56 may include industries such as material handling, packaging industries, manufacturing, processing, batch processing, the example industrial automation system 10 of FIG. 1, and the like.

The data collection system 44 may be communicatively coupled to machine learning systems. The data collection system 44 may gather and present various datasets associated with the industrial automation device 50 for customers to select to share with the machine learning systems to allow the machine learning systems to better train machine learning models. The machine learning models may be used in an industrial automation system to increase the efficiency of operations of the industrial device or related process by detecting anomalies, maintenance events, and the like.

In certain embodiments, the machine learning systems may include a computing device 58 and a cloud-based computing system 60. The computing device 58 may be one or more computing devices operated by the manufacturer, software provider, seller, service provider, operator, or owner of the device control system 48. The computing device 58 may be disposed at a facility owned and/or operated by the manufacturer, software provider, seller, service provider, operator, or owner of the device control system 48. In other embodiments, the computing device 58 may be disposed in a data center in which the manufacturer, software provider, seller, service provider, operator, or owner of the device control system 48 owns or rents server space. Likewise, the cloud-based computing system 60 may include the computing device 58, and may be operated by the manufacturer, software provider, seller, service provider, operator, or owner of the device control system 48. The device control system 48 may be communicatively coupled to the computing device 58 and the cloud-based computing system 60. In this network, input and output signals generated from the device control system 48 may be communicated between the computing device 58 and the cloud-based computing system 60. Although the device control system 48 may be capable of communicating with the computing device 58 and the cloud-based computing system 60, as mentioned above, in certain embodiments, the device control system 48 may perform certain operations and analysis without sending data to the computing device 58 or the cloud-based computing system 60.

As briefly discussed above, the device control system 48 may monitor and store data communication and outputs of the industrial automation device 50. As the device control system 48 monitors the datasets accessible to the industrial automation device 50, the device control system 48 may categorize the datasets as raw data or process data. After categorizing the accessible datasets, the device control system 48 may send data indicative of types of data information to the cloud-based computing system 60, or other suitable machine learning system. In response, the device control system 48 may receive an indication of operational model offerings related to each type of data information from the cloud-based computing system. The operational model offerings may include device models that model the correlations between operational data and operations of the industrial automation device 50, updated model parameters (e.g., updates to device models), as well as, instructions for modifying operations of the industrial automation device 50 (e.g., configuration data, software patches, software applications, etc.).

After receiving the indication of operational model offerings, the data collection system 44 may present a visualization or request to a user of the device control system 48 (e.g., the customer) via the HMI 46 to enable the user to select one or more portions of the detected datasets to make available to the cloud-based computing system 60. In some embodiments, the visualization or request may include an indication of the operational model offerings that may be made available to the user in return for providing access to the respective data. That is, if the user provides access to temperature and operational data, the data collection system 44 may identify software applications that model the correlations between the temperature and the operations of the respective device to provide operational adjustments to increase the lifespan of the respective device. Moreover, the selected datasets may be added to a data repository to allow various machine learning systems to perform various types of analysis to update models and the like.

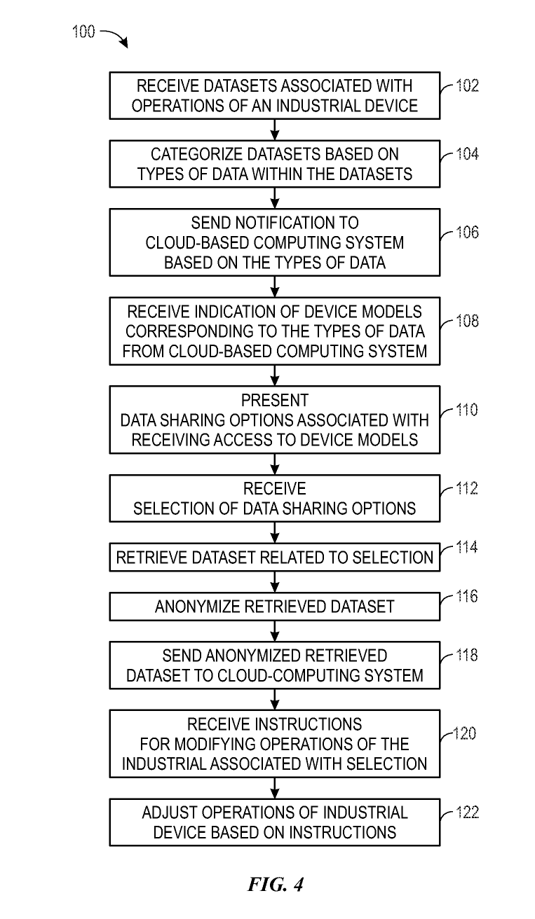

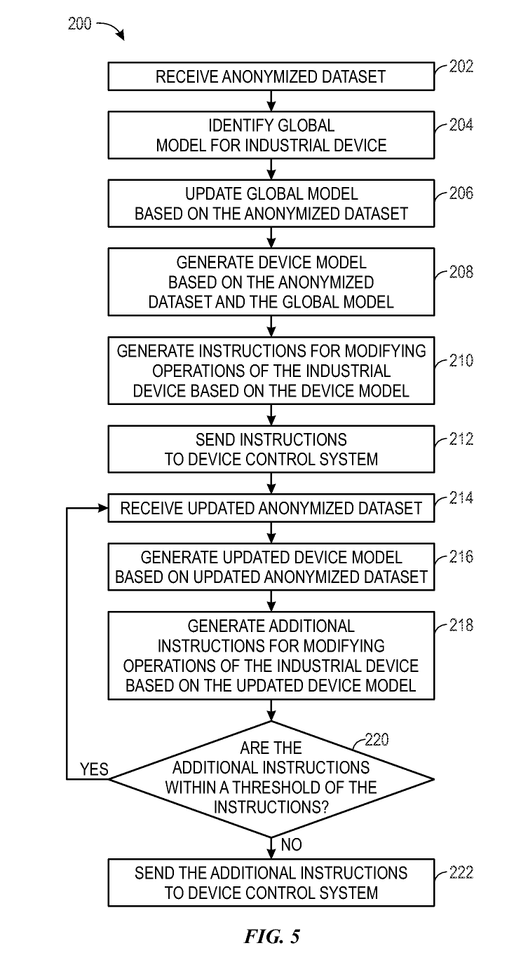

The process performed by the data collection system 44 to gather and present various datasets associated with the industrial automation device 50 for customers to select to share with the machine learning systems to allow the machine learning systems to better train machine learning models will be discussed in greater detail in regards to FIG. 4. The process performed by the cloud-based computing system 60, or other suitable machine learning system, to generate and update operational model offerings (e.g., device models customized for the customer, instructions for modifying operations of the industrial device) will be discussed in greater detail in regards to FIG. 5.

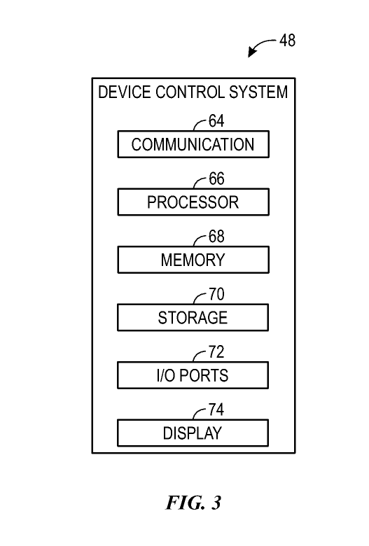

To perform some of the actions set forth above, the device control system 48 may include certain components to facilitate these actions. FIG. 3 illustrates example components that may be part of the device control system 48 or any other suitable computing device that implement embodiments presented herein. For example, the device control system 48 may include a communication component 64 (e.g., communication circuitry), a processor 66, a memory 68, a storage 70, input/output (I/O) ports 72, a display 74, and the like. The communication component 64 may be a wireless or wired communication component that may facilitate communication between the device control system 48, the cloud-based computing system 60, and other communication capable devices.

The processor 66 may be any type of computer processor or microprocessor capable of executing computer-executable code. The processor 66 may also include multiple processors that may perform the operations described below. The memory 68 and the storage 70 may be any suitable articles of manufacture that can serve as media to store processor-executable code, data, or the like. These articles of manufacture may represent computer-readable media (e.g., any suitable form of memory or storage) that may store the processor-executable code used by the processor 66 to perform the presently disclosed techniques.

The memory 68 and the storage 70 may also be used to store data, analysis of the data, software applications, and the like. For example, the memory 68 and the storage 70 may store instructions associated with categorizing the datasets accessible to the industrial automation device 50 as raw data or process data. As another non-limiting example, the memory 68 and the storage 70 may store one or more previously acquired datasets accessible to the industrial automation device 50. As another non-limiting example, the memory 68 and the storage 70 may store previously acquired operational modeling offerings, such as, software patches or applications. The memory 68 and the storage 70 may represent non-transitory computer-readable media (e.g., any suitable form of memory or storage) that may store the processor-executable code used by the processor 66 to perform various techniques described herein. It should be noted that non-transitory merely indicates that the media is tangible and not a signal.

The I/O ports 72 may be interfaces that may couple to other peripheral components such as input devices (e.g., keyboard, mouse), sensors, input/output (I/O) modules, and the like. The I/O modules may enable the device control system 48 to communicate with the computing device 58, the industrial automation device 50, or other devices in the industrial automation system.

The display 74 may operate to depict visualizations associated with software or executable code being processed by the processor 66. In one embodiment, the display 74 may be a touch display capable of receiving inputs (e.g., a selection of types of operating data to share with a machine learning system) from a user of the device control system 48. As such, the display 74 may serve as a user interface to communicate with the device control system 48. The display 74 may display a graphical user interface (GUI) for operating the device control system 48, for implementing operational model offerings (e.g., software patches or applications, suggested configuration data, local models, etc.), and the like. The display 74 may be any suitable type of display, such as a liquid crystal display (LCD), plasma display, or an organic light emitting diode (OLED) display, for example. Additionally, in one embodiment, the display 74 may be provided in conjunction with a touch-sensitive mechanism (e.g., a touch screen) that may function as part of a control interface for the device control system 48.

The components described above with regard to the device control system 48 are exemplary components. The device control system 48 may include additional or fewer components. Additionally, the industrial automation device 50, computing device 58, and cloud-based computing system 60 may also include similar components as described as part of the device control system 48.

With the foregoing in mind, FIG. 4 illustrates a flow chart of a data sharing process 100 in accordance with embodiments described here. Although the following description of the data sharing process 100 is described in a particular order, which represents a particular embodiment, it should be noted that data sharing the process 100 may be performed in any suitable order. Moreover, although the following description of the data sharing process 100 is described as being performed by the device control system 48, it should be noted that the data sharing process 100 may be performed by any suitable computing device.

Referring now to FIG. 4, at block 102, the device control system 48 may receive datasets associated with operations of the industrial device 50 by monitoring data communication and outputs by the industrial automation device 50, such as, the acquisition of data from various data sources (e.g., sensors), data output (e.g., calculations, commands) by a respective controller, datasets transmitted or received by the industrial automation device 50, and the like. For example, in certain embodiments, the industrial device 50 may be a motor drive. In such embodiments, the device control system 48 may monitor sensor data associated with the motor drive (e.g., sensor data indicating frequency, temperature, etc. of a motor controlled by the motor drive), as well as, data outputs by a controller associated with the motor drive (e.g., commands to adjust the speed of the motor, efficiency calculations, etc.). Further, the device control system 48 may store logs of the data communication and outputs by the industrial automation device 50 in one or more databases stored in the memory 68 and/or storage 70.

At block 104, the device control system 48 may categorize accessible datasets (e.g., the datasets received at block 102) as raw data or process data. The raw data may relate to data acquired by sensors for various types of equipment, while the process data may relate to datasets that have been modified, altered, or generated by logic or software executed by a respective controller and/or the device control system 48. Raw data may include thermal sensor data, pressure sensor data, position sensor data, and the like as collected by the respective sensors, that may be directly and/or indirectly associated with the industrial device 50. For example, raw data may include thermal data associated with a component of the industrial automation device 50, as well as, position data of an industrial automation device that is performing an industrial automation process with the industrial automation device 50 (e.g., position data of an industrial automation device being driven by the industrial automation device 50). The process data may include commands from the respective controller and/or device control system 48 that may be based on a control feedback loop associated with raw data. For example, if the industrial automation device 50 is a motor drive, the process data may include a command to adjust the speed of the motor based on a temperature of the motor, and/or on the position of an industrial automation device being controlled or affected by the motor. Additionally, the process data may include model parameters from a machine learning model trained by or otherwise associated with the respective controller and/or device control system 48 (e.g., model parameters associated with expected operations of the industrial automation device 50).

Moreover, the device control system 48 may further categorize the raw and process data into subcategories. For example, the device control system 48 may further categorize raw data as thermal data, pressure data, position data, velocity data, etc., and may further categorize process data as intermediate data (e.g., raw data that has been modified or used to calculate performance data such as efficiency, estimated lifespan, etc. of the industrial device 50), control data (e.g., commands used to control the industrial device 50), model parameters (e.g., model parameters modeling correlations between operating conditions and expected operations of the industrial device 50), and the like. The device control system 48 may categorize the accessible datasets by formatting the one or more databases stored in the memory 68 and/or storage 70 into tables organized by the categories and subcategories, and/or by tagging the data according to the categorizes and subcategories.

After categorizing the accessible datasets, at block 106, the device control system 48 may send a notification including types of data information to a suitable machine learning system, which may be implemented via the cloud-based computing system 60. The types of data information may include the categories used to organize the accessible datasets, such as raw data and process data, as well as the subcategories, such as thermal data, pressure data, position data, velocity data, estimated efficiency data, and the like. The device control system 48 may send the types of data information directly to the cloud-based computing system 60, or indirectly through the computing device 58 and a corresponding network.

At block 108, in response to sending the types of data information, the device control system 48 may receive an indication of operational model offerings related to each different type of data information from the cloud-based computing system 60. The operational model offerings may include device models generated for the customer based on properties of data shared with the cloud-based computing system 60, such that the device models may simulate or predict expected operations, maintenance events, and other properties associated with the operation of the respective industrial automation device 50. The device models may be generated from a global model (i.e., a model generated using datasets from various customers) based on the types of data information shared with the cloud-based computing system 60. For example, the cloud-based computing system 60 may identify and isolate portions of the global model related to the types of data information shared, such as sensor feedback (e.g., portions of the global model related to thermal sensor data, pressure sensor data), and the like. As such, the device models may include predictions based on the types of data information shared, while excluding predictions based on the types of data information that were not shared with the cloud-based computing system 60, thereby providing relevant predictions for the customer based on shared data. Additionally, the operational model offering may include instructions for modifying operations of the respective industrial automation device, such as modifications to configuration data, software patches for implementing via the device control system 48, and software applications for installation by the device control system 48 that model the correlations between operational data and operations of the respective industrial automation device 50. Additional details with regard to identifying global models and generating device models will be described with reference to FIG. 5.

After receiving the indication of operational model offerings, at block 110, the device control system 48 may present data sharing options to the user. For example, the device control system 48 may present a visualization or request to a user of the device control system (e.g., the customer) to enable the user to select one or more portions of the detected datasets to make available to the cloud-based computing system 60. In some embodiments, the device control system 48 may include an indication of the operational model offerings, such as the device models, that may be made available to the user in return for providing access to the respective data. That is, the device control system 48 may indicate that in response to the user providing access to temperature and operational data, the device control system 48 may identify device models that model the correlations between the temperature and the operations of the respective device to provide operational adjustments that may increase the lifespan of the respective device. Moreover, the device control system 48 may indicate that selected datasets may be added to a data repository to allow various machine learning systems to perform various types of analysis to update models and the like. The device control system 48 may present the data sharing options and associated operational model offerings (e.g., device models) via the integrated display 74, via the HMI 46, and/or via any suitable computing device communicatively coupled to the device control system 48. Accordingly, the device control system 48 may present the data sharing options to on-premise users, as well as remote (i.e., off-premise) users.

At block 112, the device control system 48 may receive a selection of one or more portions of the detected datasets to make available to machine learning systems. For example, the device control system 48 may receive inputs indicating the selection of one or more portions of the detected datasets via a user-interface or human-machine interface UI/HMI communicatively coupled to the device control system (e.g., the display 74, HMI 46, etc.). At block 114, in response to receiving the selection, the device control system 48 may retrieve data related to the selection. For example, the device control system 48 may query the industrial automation device 50, as well as, the one or more databases stored in the memory 68 and/or storage 70 of the device control system 48, to gather the selected one or more portions of the detected datasets. That is, based on the selection of the raw data within the accessible datasets, the device control system 48 may query the industrial automation device 50 to retrieve current sensor readings from each sensor coupled to and associated with the industrial automation device 50, as well as, query the one or more databases (e.g., filter for raw data) to retrieve historic sensor data previously monitored and stored by the device control system 48.

At block 116, the device control system 48 may anonymize the retrieved dataset. For example, after retrieving the selected dataset from the industrial device 50 and/or from the one or more databases stored in the memory 68 and/or storage 70, the device control system 48 may remove any meta-data associating the dataset with the customer, such as tags including location data, identifiers, and the like that could be used to identify the customer. At block 118, the device control system 48 may send the anonymized retrieved dataset to the cloud-based computing system 60, either directly or through the computing device 58 that is communicatively coupled to both the device control system 48 and the cloud-based computing system 60. The cloud-based computing system 60 may use data within the anonymized dataset to identify and update relevant global models, as well as, generate device models for the industrial device 50. As such, although the anonymized dataset may obfuscate information related to the source of the data, the anonymized dataset may still have information related to the type of industrial device, operational settings, load characteristics, and the like to allow the cloud-based computing system 60 to identify and update corresponding models. Additional details with regard to updating a global model and generating a device model will be described with reference to FIG. 5.

At block 120, the device control system 48 may receive instructions for modifying operations of the industrial device from the cloud-based computing system 60 associated with the selection of one or more portions of the detected datasets, as part of the operational model offerings. For example, the device control system 48 may receive the instructions directly from the cloud-based computing system 60, or indirectly via any the computing device 58, or any suitable computing device associated with customer and communicatively coupled to the cloud-based computing system 60 and the device control system 48. The instructions may include suggested modifications to configuration data, software patches for implementing via the device control system 48, and software applications for installation by the device control system 48 that model the correlations between operational data and operations of the respective industrial automation device 50. Further, the instructions may include suggested remedial actions to take in response to detected anomalies or unexpected events during operation of the industrial device 50. For example, the remedial actions may include taking the industrial device offline, replacing a component (e.g., fastener, valve, etc.) of the industrial device 50, updating the configuration data, and the like. Accordingly, the instructions may be implemented via the device control system 48 directly, or may be implemented by an operator of the device control system 48.

At block 122, after receiving the instructions, the device control system 48 may adjust operations of the industrial device 50 based on the instructions. For example, the device control system 48 may deploy updated configuration data in response to receiving instructions related to correlations between the temperature and the operations of the industrial device to increase the lifespan of the industrial device 50. Additionally, the device control system 48 may deploy a software patch and/or software application and adjust the operations of the industrial device 50 accordingly. That is, the device control system may deploy a software patch associated with an updated control regime (e.g., updated logic) for controlling the industrial device 50.

While not illustrated in FIG. 4, the device control system 48 may additionally, or alternatively, receive a device model from the cloud-based computing system 60 in return for providing access to the respective anonymized dataset. The device model may include correlations between the types of operational data contained in the anonymized dataset and operations of the industrial device 50, while excluding correlations between types of data not found in the anonymized dataset and operations of the industrial device 50, thereby providing a relevant model for the customer based on the shared data. In such cases, after receiving the device model, the device control system 48 may adjust operations of the industrial device 50 based on the device model. For example, if the device model includes correlations between the pressure and the operations of the industrial device and suggests operational adjustments, such as updated configuration data to increase the lifespan of the industrial device 50, the device control system 48 may implement the suggested operational adjustments by deploying the updated configuration data.

Additionally or alternatively, when the respective anonymized dataset includes model parameters from a machine learning model trained by, hosted by, or otherwise associated with the respective controller and/or device control system 48 (e.g., model parameters associated with expected operations of the industrial device 50), the device control system 48 may receive updated model parameters or instructions including one or more modifications to the model parameters from the cloud-based computing system 60 for the machine learning model in return for providing access to the respective anonymized dataset. Accordingly, the device control system 48 may receive updated model parameters to improve the machine learning model without sharing raw data or the machine learning model itself with the cloud-based computing system 60, thereby improving data privacy for the device control system 48 by limiting a scope of data shared with the cloud-based computing system 60.

Accordingly, the data sharing process 100 of the device control system 48 may allow users to select one or more portions of one or more datasets accessible to industrial device 50 (e.g., data associated with data communication with other industrial devices and data outputs by the industrial device 50) to share with the cloud-based computing system 60, or any other suitable machine learning systems. Additionally, in response to sharing one or more portions of one or more datasets associated with the industrial device 50, the users may receive operational model offerings from the cloud-based computing system 60 associated with the respective types of operational data shared, such as instructions for modifying operations of the industrial device 50, a device model, updated model parameters, and the like. Moreover, the users may utilize the operational model offerings to adjust the operations of the industrial device 50 to increase efficiency of operations, extend the lifespan of the industrial device, and the like.

In response to receiving anonymized datasets associated with the industrial automation device 50, according to the data sharing process 100 of FIG. 4, the cloud-based computing system 60 may generate and update machine learning models, generate operational model offerings, and share the operational model offerings with the customer. Further, the cloud-based computing system 60 may receive updates to the anonymized datasets continuously and/or at predetermined time intervals (e.g., every minute, hour, day, week, etc.). The cloud-based computing system 60 may update the machine learning models as well as the operational model offerings (e.g., device models, instructions, etc.) based on the updated anonymized datasets. When the updated operational model offerings are not within a threshold of the operational model offerings (e.g., exceed 0.5% deviation, 5% deviation, etc.), the cloud-based computing system 60 may send the updated operational model offerings to the customer. In this way, the cloud-based computing system 60 may only send updated operational model offerings to the customer when the updated anonymized datasets cause a substantive change in the operational model offerings.

With the foregoing in mind, FIG. 5 illustrates a flow chart of a model training and data sharing process 200 in accordance with embodiments described here. Although the following description of the model training and data sharing process 200 is described in a particular order, which represents a particular embodiment, it should be noted that model training and data sharing the process 200 may be performed in any suitable order. Moreover, although the following description of the model training and data sharing process 200 is described as being performed by the cloud-based computing system 60, it should be noted that the model training and data sharing process 200 may be performed by any suitable machine learning system.

Referring now to FIG. 5, at block 202, the cloud-based computing system 60 may receive an anonymized retrieved dataset from the device control system 48 (i.e., the anonymized retrieved dataset sent by the device control system 48 at block 118 of FIG. 4). As discussed above, the anonymized dataset may include data retrieved from the industrial device 50 and/or from the one or more datasets stored in the memory 68 and storage 70 of the device control system 48 according to the selected type(s) of data information to share with machine learning systems (e.g., raw, process, thermal, position, model parameters, etc.), with any meta-data associating the datasets with the customer removed. The cloud-based computing system 60 may receive the anonymized datasets directly from the device control system 48, and/or indirectly through the computing device 58 and a corresponding network.

At block 204, in response to receiving the anonymized dataset, the cloud-based computing system 60 may identify a global model (e.g., a machine learning model trained using datasets from various customers) associated with industrial device and the data type(s) (e.g., raw, processed, etc.) corresponding to the retrieved dataset(s). The cloud-based computing system 60 may be in communication with various device control systems deployed within various industrial automation systems operated by various customers. Accordingly, the cloud-computing system 60 may generate and train a number of global models based on datasets from various customers. When the cloud-based computing system 60 receives an anonymized dataset, the cloud-based computing system 60 may identify a global model from the plurality of global models based on features of the anonymized dataset (e.g., the respective industrial device, the respective data type, etc.). For example, if the cloud-based computing system 60 receives an anonymized dataset including temperature and operational data for a motor (i.e., the industrial device 50), the cloud-based computing system 60 may identify a global model of the motor trained using temperature and operational data from various customers.

As referenced herein, the global model of any particular industrial device may characterize one or more operational features (e.g., temperature, pressure, power consumption) of the respective industrial device with respect to certain variables (e.g., input variables, input power, load size). In this way, the global model may use the data made available to it to characterize expected operational parameters for the respective industrial device over time, with respect to certain operating conditions, input parameters, and the like.

After the cloud-based computing system 60 identifies a relevant global model, at block 206, the cloud-based computing system 60 may update the global model based on the anonymized dataset. For example, the cloud-based computing system 60 may input data from the anonymized dataset into a data repository used to train the global model. Additionally, in some embodiments, the cloud-based computing system 60 may add data from the anonymized dataset to a shared data repository to allow various machine learning systems to perform various types of analysis to update models and the like.

At block 208, the cloud-based computing system 60 may generate a device model for the industrial device 50 based on the anonymized data and the updated global model. For example, the cloud-based computing device may identify and isolate portions of the updated global model related to the types of operational data contained in the anonymized dataset, such as sensor feedback (e.g., portions of the model related to thermal sensor data, pressure sensor data, etc.), controller commands (e.g., logic used to control the industrial device 50), and the like. As such, the device model may include correlations between the types of operational data contained in the anonymized dataset and operations of the industrial device 50, while excluding correlations between types of data not found in the anonymized dataset and operations of the industrial device, thereby generating a relevant model of the industrial device 50 for the customer based on the shared data. For example, if the customer selected temperature and operational data to share with machine learning systems, the device model may include correlations between the temperature and the operations of the industrial device 50 and suggests operational adjustments (e.g., updated configuration data) to increase the lifespan of the industrial device, without including correlations and suggestions regarding data types not found in the anonymized dataset (e.g., position data, velocity data, etc.).

At block 210, the cloud-based computing system 60 may generate instructions for modifying operations of the industrial device 50 based on the device model. That is, the cloud-based computing system 60 may identify suggested modifications to configuration data, a software patch, and/or application based on the device model. For example, if the anonymized dataset includes temperature data for the industrial device 50, the cloud-based computing system 60 may analyze the temperature data with respect to the device model to identify an application directed towards minimizing overheating associated with operations of the industrial device 50 based on the device model indicating that overheating events may be expected to occur. At block 212, the cloud-based computing system 60 may send the instructions to the device control system 48. For example, the cloud-based computing system 60 may send the instructions directly to the device control system 48, or indirectly via any suitable computing device associated with customer and communicatively coupled to the device control system 48 (e.g., computing device 58). Additionally, or alternatively, the cloud-based computing system 60 may send the device model to the device control system 48, which may, in turn, adjust operations of the industrial device 50 based on the device model.

At block 214, the cloud-based computing system 60 may receive an updated anonymized dataset from the data collection system 44. The updated anonymized dataset may include new data corresponding to the selected type(s) of data. For example, if the customer selected raw data to share with machine learning systems, the cloud-based computing system may receive an updated anonymized dataset containing additional sensor data associated with the industrial automation device 50 from a sensor recently put online (i.e., added to the industrial automation system). Likewise, if a sensor associated with the industrial automation device 50 goes offline, either due to an unexpected event or a scheduled maintenance event, the updated anonymized dataset may indicate the loss of the respective data stream (e.g., if a position sensor goes offline, the updated anonymized dataset may lack any position data). The cloud-based computing system 60 may receive updates to the anonymized data set continuously and/or at predetermined time intervals (e.g., every minute, hour, day, week, etc.).

At block 216, the cloud-based computing system 60 may generate an updated device model based on the updated anonymized dataset. For example, the cloud-based computing system 60 may further update the relevant global model(s) based on the updated anonymized data, and may identify and isolate portions of the updated global model(s) related to the types of operational data contained in the anonymized dataset, such as sensor feedback (e.g., portions of the global model related to thermal sensor data, pressure sensor data, etc.), controller commands (e.g., logic used to control the industrial device 50), and the like, to generate the updated device model. The cloud-based computing system 60 may input data from the updated anonymized dataset into the data repository used to train the global model identified at block 206. Additionally, in some embodiments, the cloud-based computing system 60 may add data from the updated anonymized dataset to the shared data repository to allow various machine learning systems to perform various types of analysis to further update models and the like.

At block 218, the cloud-based computing system 60 may generate additional instructions for modifying operations of the industrial device 50 based on the updated device model. That is, the cloud-based computing system 60 may identify additional or alternative modifications to configuration data, software patches, software applications, and the like, based on the updated device model. For example, if the anonymized dataset includes temperature data for the industrial device 50, the cloud-based computing system 60 may analyze the temperature data with respect to the updated device model to identify an application directed towards maximizing efficiency associated with operations of the industrial device 50 based on the updated device model indicating that overheating events may no longer be expected to occur. At block 220, the cloud-computing device may compare the additional instructions to the instructions. If the additional instructions are within a threshold (e.g., 0.5% deviation, 5% deviation, etc.) of the instructions, the cloud-based computing system 60 may return to block 214, and may continue to receive updated anonymized data from the data collection system 44 without sending the additional instructions to the device control system 48. If the additional instructions are not within the threshold of the instructions (e.g., exceeds 0.5% deviation, 5% deviation, etc.), the cloud-based computing system 60 may proceed to block 222, and may send the additional instructions to the device control system 48. In this way, the cloud-based computing system 60 may only send additional instructions when the updated anonymized datasets cause a substantive change in the device model or suggested resources.

Accordingly, the model training and data sharing process 200 of the cloud-based computing system 60 may train global models using one or more portions of data accessible to industrial device 50 (e.g., data associated with data communication with other industrial devices and data outputs by the industrial device 50) from various customers. Therefore, the cloud-based computing system 60 may generate machine learning models with an efficient use of computing resources (e.g., energy, processing power, storage), and in a less cost prohibitive and less disruptive manner than machine learning systems training models using data from a single customer (e.g., plant, industrial automation system, etc.), as the cloud-based computing system 60 may gain access to a larger and more diverse dataset over a similar span of time. Additionally, the cloud-based computing system 60 may generate and share device models and instructions for modifying operations of the industrial device 50 (e.g., suggested modifications to configuration data, software patches, software applications, and the like), in response to receiving one or more portions of one or more datasets associated with the industrial device 50 from the data collection system 44 via the device control system 48, based on the respective types of operational data shared. Accordingly, customers may utilize the operational model offerings (e.g., instructions, device models) to adjust the operations of the industrial device 50 to increase efficiency of operations, extend the lifespan of the industrial device, and the like.

Embodiments of the present disclosure may present various datasets associated with an industrial automation device for customers to select to share with machine learning systems, such as the cloud-based computing system, to allow the machine learning systems to better train machine learning models. The machine learning models may be used in an industrial automation system to increase the efficiency of operations of the industrial device or related process by suggesting updated configuration data and detecting anomalies, maintenance events, and the like.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

While only certain features of the embodiments described herein have been illustrated and described, many modifications and changes will occur to those skilled in the art. It is, therefore, to be understood that the appended claims are intended to cover all such modifications and changes as fall within the true spirit of the embodiments described herein

1. A system, comprising:
an industrial device in operation within an industrial system; and
a processing system configured to:
receive an anonymized dataset associated with one or more operations of the industrial device from a control system associated with the industrial device;
identify a model representative of one or more expected operations of the industrial device over time based on the dataset, wherein the model is generated based on a plurality of anonymized datasets associated with a plurality of industrial devices corresponding to the industrial device;
update the model based on the dataset to generate an updated model;
generate a device model based on the dataset and the updated model, wherein the device model is representative of one or more expected outputs associated with the one or more operations of the industrial device;
generate one or more instructions for modifying the one or more operations of the industrial device based on the device model; and
send the one or more instructions to the control system, wherein the control system is configured to modify the one or more operations of the industrial device based on the one or more instructions.

2. The system of claim 1, wherein the control system is configured to:
receive one or more datasets associated with the one or more operations of the industrial device;
categorize the one or more datasets based on one or more types of data associated with the one or more datasets;
send a notification representative of the one or more types of data associated with the one or more datasets to the processing system;
receive an additional notification representative of one or more device models corresponding to the one or more types of data associated with the one or more datasets from the processing system, wherein the additional notification comprises one or more data sharing options associated with receiving access to the one or more device models;
receive a selection of one of the one or more data sharing options, wherein the one of the one or more data sharing options corresponds to:
the device model; and
one of the one or more types of data;
retrieve a dataset of the one or more datasets based on the selection; and
send the dataset to the processing system.

3. The system of claim 2, wherein the control system is configured to anonymize the dataset prior to sending the dataset to the processing system.

4. The system of claim 1, wherein the one or more instructions correspond to one or more modifications to configuration data, one or more software patches for implementation via the control system, one or more software applications for installation by the control system, or any combination thereof.

5. The system of claim 1, wherein the processing system is configured to:
receive an updated anonymized dataset associated with the one or more operations of the industrial device from the control system;
update the device model based on the updated dataset to generate an updated device model;
generate one or more additional instructions for modifying the one or more operations of the industrial device based on the updated device model; and
send the one or more additional instructions to the control system based on the one or more additional instructions exceeding a threshold of the one or more instructions, wherein the control system is configured to modify the one or more operations of the industrial device based on the one or more additional instructions.

6. The system of claim 1, wherein the processing system is configured to detect an occurrence of an unexpected event during operation of the industrial device based on the device model.

7. The system of claim 6, wherein the one or more instructions correspond to one or more remedial actions to address the unexpected event, and wherein the one or more remedial actions comprise taking the industrial device offline, replacing a component of the industrial device, updating configuration data, or any combination thereof.

8. A tangible, non-transitory, computer-readable medium comprising processor-executable instructions that, when executed by one or more processors, causes the one or more processors to perform operations comprising:
receiving an anonymized dataset associated with one or more operations of an industrial device;
identifying a model representative of one or more expected operations of the industrial device over time based on the dataset, wherein the model is generated based on a plurality of anonymized datasets associated with a plurality of industrial devices corresponding to the industrial device;
updating the model based on the dataset to generate an updated model;
generating a device model based on the dataset and the updated model, wherein the device model is representative of one or more expected outputs associated with the one or more operations of the industrial device; and
sending the one or more instructions to a control system associated with the industrial device, wherein the control system is configured to modify the one or more operations of the industrial device based on the one or more instructions.

9. The computer-readable medium of claim 8, wherein the operations further comprise:
receiving an updated anonymized dataset associated with the one or more operations of the industrial device;
updating the device model based on the updated dataset to generate an updated device model;
generating one or more additional instructions for modifying the one or more operations of the industrial device based on the updated device model; and
sending the one or more additional instructions to the control system based on the one or more additional instructions exceeding a threshold of the one or more instructions, wherein the control system is configured to modify the one or more operations of the industrial device based on the one or more additional instructions.

10. The computer-readable medium of claim 8, wherein the operations comprise detecting an occurrence of an unexpected event during operation of the industrial device based on the device model.

11. The computer-readable medium of claim 10, wherein the one or more instructions correspond to one or more remedial actions to address the unexpected event, and wherein the one or more remedial actions comprise taking the industrial device offline, replacing a component of the industrial device, updating configuration data, or any combination thereof.

12. The computer-readable medium of claim 8, wherein the one or more instructions correspond to one or more modifications to configuration data, one or more software patches for implementation via the control system, one or more software applications for installation by the control system, or any combination thereof.

13. The computer-readable medium of claim 8, wherein receiving the anonymized dataset comprises:
receiving a notification representative of one or more types of data associated with one or more datasets associated with the one or more operations of the industrial device from the control system;
sending an additional notification representative of one or more device models corresponding to the one or more types of data associated with the one or more datasets to the control system, wherein the additional notification comprises one or more data sharing options associated with receiving access to the one or more device models; and
receiving the anonymized dataset from the control system based on a selection of one of the one or more data sharing options.

14. The computer-readable medium of claim 13, wherein the one of the one or more data sharing options corresponds to the device model and one of the one or more types of data.

15. A system, comprising:
an industrial device associated with an industrial system;
a control system configured to control operations of the industrial device; and
a processing system configured to:
receive an anonymized dataset associated with one or more operations of the industrial device;
identify a model representative of one or more expected operations of the industrial device over time based on the dataset, wherein the model is generated based on a plurality of anonymized datasets received from a plurality of industrial systems;
generate a device model based on the dataset and the model, wherein the device model is representative of one or more expected outputs associated with the one or more operations of the industrial device; and
send one or more instructions to the control system based on the device model, wherein the control system is configured to modify the one or more operations of the industrial device based on the one or more instructions.

16. The system of claim 15, wherein the control system is configured to:
receive one or more datasets associated with the one or more operations of the industrial device;
categorize the one or more datasets based on one or more types of data associated with the one or more datasets;
send a notification representative of the one or more types of data associated with the one or more datasets to the processing system;
receive an additional notification representative of one or more device models corresponding to the one or more types of data associated with the one or more datasets from the processing system, wherein the additional notification comprises one or more data sharing options associated with receiving access to the one or more device models;
receive a selection of one of the one or more data sharing options, wherein the one of the one or more data sharing options corresponds to the device model and one of the one or more types of data;
retrieve a dataset of the one or more datasets based on the selection;
anonymize the dataset; and
send the anonymized dataset to the processing system.

17. The system of claim 15, wherein the processing system is configured to:
receive an updated anonymized dataset associated with the one or more operations of the industrial device;
update the device model based on the updated dataset to generate an updated device model;
generate one or more additional instructions for modifying the one or more operations of the industrial device based on the updated device model; and
send the one or more additional instructions to the control system based on the one or more additional instructions exceeding a threshold of the one or more instructions, wherein the control system is configured to modify the one or more operations of the industrial device based on the one or more additional instructions.

18. The system of claim 15, wherein the anonymized dataset comprises model parameters generated by an additional model trained or executed by the control system, and the one or more instructions correspond to one or more modifications to the model parameters for implementation via the control system.

19. The system of claim 15, wherein the processing system is configured to detect an occurrence of an unexpected event during operation of the industrial device based on the device model.

20. The system of claim 19, wherein the one or more instructions correspond to one or more remedial actions to address the unexpected event, and wherein the one or more remedial actions comprise taking the industrial device offline, replacing a component of the industrial device, updating configuration data, or any combination thereof.
